(19) United States
(12) Patent Application Publication
(10) Pub. No.: US 2009/0011320 A1
(43) Pub. Date: Jan. 8, 2009

(54) CATALYST-SUPPORTING POWDER AND METHOD FOR PRODUCING SAME

(75) Inventor: Yui Senda, Kanagawa (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: GS YUASA CORPORATION, Kyoto (JP)

(21) Appl. No.: 11/815,721

(22) PCT Filed: Feb. 7, 2006
(86) PCT No.: PCT/JP2006/302081

§ 371 Date: Aug. 7, 2007

(30) Foreign Application Priority Data
Feb. 7, 2005 (JP) 2005-030949

(51) Int. Cl. H01M 4/86; H01M 4/88; B01J 27/12

(52) U.S. Cl. 429/40; 502/101; 502/224

(57) ABSTRACT

The catalyst-supporting powder is in form of an agglomerate formed by agglomeration of a fluorine atom-containing polymer material, a catalyst metal, a cation exchange resin, and a carbon material and the polymer material is contained in the inside of the agglomerate.

### BACKGROUND OF THE INVENTION

1. Field of the Invention

The present invention relates to a catalyst-supporting powder to be used for a polymer electrolyte fuel cell.

2. Description of the Related Art

A single cell of a polymer electrolyte fuel cell (PEFC) has a structure of a membrane electrode assembly existing between a pair of gas flow plates. The membrane electrode assembly is obtained by bonding an anode to one face of a cation exchange membrane and a cathode to the other face. A gas channel is processed in each of the gas flow plates and for example, hydrogen as a fuel and oxygen as an oxidant are supplied to the anode and the cathode, respectively, to generate electric power. In the anode and the cathode, the following electrochemical reactions proceed.

Anode: 2H₂→4H⁺+4e⁻ (1)

Cathode: O₂+4H⁺+4e⁻→H₂O (2)

The above-mentioned electrochemical reactions proceed in an interface of a region where either hydrogen or oxygen with a proton (H⁺) is transmitted and a catalyst (hereinafter, the interface is referred to as a reaction site). Since the catalyst is in contact with an electron conductive material, an electron (e⁻) is collected through the material.

Conventionally, as a catalyst-supporting powder for a polymer electrolyte fuel cell have bee known a mixture containing an electrode catalyst (one obtained by depositing an active catalyst metal particle on a catalyst carrier such as carbon black), PTFE (polytetrafluoroethylene), and a material having an ion exchange function. With respect to that, Japanese Patent Application Laid-Open (JP-A) No. 06-068880, which is a publication of a Japanese patent application, discloses such a powder. Further, as a production method of a catalyst-supporting powder for PEFC is mentioned a production method involving adding a carbon powder subjected to water repelling treatment by adding PTFE and a carbon powder supporting a platinum catalyst to carbon supporting a catalyst metal or a colloidal dispersion of a solid polymer electrolyte. With respect to that, JP-A No. 08-088007, which is a publication of a Japanese patent application, discloses such a method.

However, since a large quantity of platinum is required to produce a polymer electrolyte fuel cell using these catalyst-supporting powders, it has been required to save the catalyst-supporting powders while maintaining the catalytic activity.

Accordingly, those which have been recently developed are catalyst-supporting powders containing agglomerates (granulated bodies) of platinum to be a catalyst, a cation exchange resin, and a carbon material and the platinum is located mainly on a site where of a proton conductive passage of the cation exchange resin contacts a surface of the carbon material. Since the site where of the proton conductive passage of the cation exchange resin contacts the surface of the carbon material is a position where giving and receiving of an electron and a proton are simultaneously carried out, platinum being effective for the electrode reaction is required in the site. On the other hand, platinum which is located on other sites are not effective for the electrode reaction. Accordingly, if the ratio of platinum located on the site where the proton conductive passage contacts the surface of the carbon material is increased, even if the amount of platinum to be used is small, the electrode reaction is able to efficiently proceed. Consequently, the needed amount of platinum is able to be decreased. Such a catalyst-supporting powder is called as “Ultra-Low Platinum Loading Carbon” (hereinafter, abbreviated as ULPLC), and disclosed in JP-A Nos. 2000-012041 and 2003-257439, which are publications of Japanese patent applications. This ULPLC presently draws attention as one of technical components for saving the cost for industrialization of polymer electrolyte fuel cells.

### SUMMARY OF THE INVENTION

However, polymer electrolyte fuel cells using ULPLC have a problem that the cell voltage tends to be low as compared with polymer electrolyte fuel cells using conventional catalyst-supporting powders. On the basis of the results of investigations made by the present inventors, it was found that the cause of this problem is a “flooding phenomenon”.

The flooding phenomenon means that water produced by a reaction is not discharged and covers the catalyst surface to inhibit catalysis of the catalyst and that a hydrogen gas or an oxygen gas, which is a reactant gas, is inhibited from reaching the reaction site from out of the system due to clogging of a diffusion channel of a gas. If this phenomenon is caused, no reaction occurs in the reaction site where no gas reaches and a current density becomes uneven, so that the cell voltage of a polymer electrolyte fuel cell is decayed.

Moreover, it was made clear by investigations carried out by a research group including the present inventors that a catalyst layer containing the ULPLC is more affected by porosity of the catalyst layer as compared with a catalyst layer containing a conventional catalyst-supporting powder. That is, the cell voltage of a polymer electrolyte fuel cell with a catalyst layer is improved by increasing porosity of the catalyst layer, and the extent of the improvement becomes large in the case of a fuel cell using ULPLC as compared with a case of a conventional fuel cell. The fact that the catalyst layer tends to be affected by the porosity means that the flooding phenomenon occurs in the catalyst layer and the effect becomes significant in the case water clogs a diffusion channel of a gas. Therefore, the cell voltage of the polymer electrolyte fuel cell is decayed to a farther extent.

Accordingly, it is required for ULPLC which tends to be affected by the porosity to have a higher water repelling effect than a conventional catalyst supporting powder.

In view of the above state of the art, it is an aim of the present invention to solve the problem that the cell voltage of a polymer electrolyte fuel cell using a catalyst-supporting powder is decayed. That is, the aim of the present invention is to provide a water repelling property to a catalyst-supporting powder to be used for a polymer electrolyte fuel cell and accordingly suppress the flooding phenomenon. Another aim of the present invention is to suppress decay of the cell voltage of the polymer electrolyte fuel cell.

The characteristics of the present invention are as follows.

The catalyst-supporting powder of the present invention is in form of an agglomerate formed by agglomeration of a fluorine atom-containing polymer material, a catalyst metal, a cation exchange resin, and a carbon material and is characterized in that the polymer material is contained in the inside of the agglomerate.

The present invention is characterized in that the catalyst metal is located mainly on a site where a proton conductive passage of the cation exchange resin contacts the carbon material.

The present invention is characterized in that the ratio of the polymer material to the carbon material is not lower than 10 mass % and not higher than 120 mass %.

With respect to a production method of the catalyst-supporting powder, the present invention is characterized in that the production method involves a first step of producing a mixture of a fluorine atom-containing polymer material, a cation exchange resin, a carbon material, and a solvent; a second step of obtaining a mixed powder of the polymer material, the cation exchange resin, and the carbon material by drying the mixture; a third step of adsorbing a cation of a catalyst metal on a fixed ion of the cation exchange resin in the mixed powder; and a fourth step of reducing the cation.

The present invention is characterized in that it is a membrane electrode assembly for a polymer electrolyte fuel cell containing such a catalyst-supporting powder.

The present invention is characterized in that it is a polymer electrolyte fuel cell comprising such a membrane electrode assembly for a polymer electrolyte fuel cell.

The catalyst-supporting powder having the above-mentioned characteristics will be specifically described below.

(1) The catalyst-supporting powder of the present invention is in form of an agglomerate formed by agglomeration of a fluorine atom-containing polymer material, a catalyst metal, a cation exchange resin, and a carbon material and is characterized in that the polymer material is contained in the inside of the agglomerate.

To suppress the flooding phenomenon of the catalyst-supporting powder, a fluorine atom-containing polymer material, which was used also for a conventional catalyst metal, can be used. That is, it is a method of mixing a catalyst-supporting powder containing a catalyst metal, a cation exchange resin, and a carbon material with PTFE showing a water repelling property. Even if this method is employed, the polymer material is never contained in the inside of the catalyst-supporting powder. (This will be described practically in Comparative Example 2 to be described later). The polymer material is simply disposed on the surface of the catalyst-supporting powder.

On the other hand, the catalyst-supporting powder of the present invention is characterized in that the polymer material is contained in the inside of the catalyst-supporting powder which is an agglomerate. As described above, the polymer material is contained in the inside of the catalyst-supporting powder, which is an agglomerate, so that the water-repelling effect can be obtained even in the inside of the catalyst-supporting powder. As a result, the effect of the water repelling property provided by the fluorine-containing polymer material is caused in the reaction sites showing electrochemical activity and their vicinities. That is, the water repelling effect is exhibited at the positions where the water repelling effect is truly needed, so that the effect of the catalyst-supporting powder of the present invention for suppressing the flooding becomes considerably significant as compared with a catalyst-supporting powder which does not at all contain the fluorine atom-containing polymer material and a catalyst-supporting powder with the fluorine atom only on the surface of powder.

(2) The catalyst-supporting powder of the present invention is characterized in that the catalyst metal is located mainly on a site where a proton conductive passage of the cation exchange resin contacts the carbon material.

The catalyst-supporting powder in which the catalyst metal is located mainly on the site where the proton conductive passage of the cation exchange resin contacts the carbon material has a high utilization of the catalyst metal (this will be described practically later) and the catalyst metal exists in the inside of the proton conductive passage, which is a hydrophilic region. Therefore, water generated by the reaction is not discharged promptly out of the system from the vicinity of the catalyst metal. As a result, the catalyst layer containing this catalyst-supporting powder tends to decay the cell voltage due to flooding as compared with the case of a conventional catalyst-supporting powder. Consequently, since the flooding phenomenon can be suppressed by making the fluorine atom-containing polymer material contained in the inside of the catalyst-supporting powder, which is in form of an agglomerate, it is made possible to exhibit a high utilization of the catalyst metal which this catalyst-supporting powder intrinsically has.

Further, in the case of an electrode for a polymer electrolyte fuel cell using the catalyst-supporting powder of the present invention, the catalyst metal is located mainly on the site where the proton conductive passage where a proton, water, hydrogen and oxygen relevant to the reaction are mainly movable, and the surface of the carbon material. Since this site is a place where giving and receiving of an electron and a proton can be carried out simultaneously, the catalyst metal supported on this site is able to be effective for the electrode reaction. Accordingly, the utilization of the catalyst metal is considerably increased and the use amount of the catalyst metal can be saved by increasing the utilization of the catalyst metal located on the site where the proton conductive passage contacts the carbon material.

Herein, with respect to the catalyst layer of the electrode for a polymer electrolyte fuel cell of the present invention, “the catalyst metal is located mainly on the site where the proton conductive passage of the cation exchange resin contacts the carbon material” means that the amount of the catalyst metal supported on the site where the proton conductive passage of the cation exchange resin contacts the surface of the carbon material is 50 mass % or higher in the total catalyst metal supporting amount. That is, since 50 mass % or more in the total catalyst metal supporting amount is effective for the electrode reaction, the utilization of the catalyst metal is considerably increased.

In this connection, in the present invention, it is more preferable as the ratio of the amount of the catalyst metal located on the site where the carbon material contacts the proton conductive passage of the cation exchange resin in the total catalyst metal supporting amount is higher, and it is particularly preferable that the ratio exceeds 80 mass %. Thus, the catalyst-supporting powder, and the catalyst layer and the electrode using the same can be highly activated by locating the catalyst metal at a high ratio in the site where the proton conductive passage contacts the carbon material.

With respect to the catalyst-supporting powder of the present invention, the catalyst metal is located mainly on the site where the proton conductive passage of the cation exchange resin contacts the carbon material, and as described in a document (M. Kohmoto et. al., GS Yuasa Technical Report, 1, 48 (2004)), it is made clear on the basis of change in the electrochemically active surface area of platinum, which is a catalyst, with the operation time and comparison of mass activity in an electrode for a polymer electrolyte fuel cell.

With respect to the change in the electrochemically active surface area of platinum with the operation time, the electrochemically active surface area of platinum is decreased by agglomeration of the platinum due to a dissolution and precipitation reaction of platinum. However, in the electrode using the catalyst-supporting powder of the present invention, the agglomeration is scarcely caused.

In the case of operation of the polymer electrolyte fuel cell at a low current density, all the platinum catalyzes the electrochemical reaction. However, in the case of operation of the polymer electrolyte fuel cell at a high current density, only platinum existing in the proton conductive passage of the cation exchange resin is effective for the electrochemical reaction and platinum existing in the hydrophobic skeleton part is not effective for the electrochemical reaction.

Further, the mass activity ratio (ratio in comparison with a conventional one) of the electrode using the catalyst-supporting powder of the present invention is approximately 1 in a voltage region higher than 0.70 V in the case of operation of the polymer electrolyte fuel cell and becomes 2.7 at 0.60 V. On the other hand, the volume ratio of the proton conductive passage in the polymer part is about 2.5 in the cation exchange resin. From these facts, it is made clear that in the case of a conventional electrode, platinum existing in the proton conductive passage of the cation exchange resin as well as platinum existing in the hydrophobic skeleton part are active in a voltage region higher than 0.70 V, meanwhile only platinum existing in the proton conductive passage of the cation exchange resin is active at 0.60 V. The mass activity means the value calculated by dividing the current density at a certain voltage by the amount of the deposited catalyst metal per unit surface area.

(3) The catalyst-supporting powder of the present invention is produced by the following method.

The first step of the present invention is characterized in that a mixture of a cation exchange resin, a carbon material, a solvent, and further a fluorine atom-containing polymer material is produced. The fluorine atom-containing polymer material to be added in this case is to be contained in the inside of the catalyst-supporting powder being in form of an agglomerate obtained consequently by the production method. The fluorine atom-containing polymer material contained in the inside brings the water-repelling effect, which is the effect of the present invention, that is, the effect of suppressing the “flooding phenomenon”. Herein, in the first step, to carry out mixing of the cation exchange resin, the carbon material, and the fluorine atom-containing polymer material evenly, it is preferable for the cation exchange resin and the fluorine atom-containing polymer material to be in powder state or be dispersed or dissolved in a solvent.

In the second step, a mixed powder of the cation exchange resin, the carbon material, and the fluorine atom-containing polymer material is obtained by drying the mixture obtained in the first step to remove the solvent. Spray drying of the mixture of the cation exchange resin, the carbon material, the fluorine atom-containing polymer material, and the solvent is one of the methods for carrying out the drying.

In the third step, a cation of a catalyst metal is adsorbed on a fixed ion of the cation exchange resin in the mixed powder obtained in the second step. The mixed powder contains the cation exchange resin, the carbon material, and the fluorine atom-containing polymer material.

In the third step, the cation of the catalyst metal is adsorbed preferentially on the cation exchange resin by, for example, immersing the mixed powder containing the cation exchange resin, the carbon material and the fluorine atom-containing polymer material in an aqueous solution containing the cation of the catalyst metal element to cause an ion exchange reaction between the cation of the catalyst metal and the fixed ion of the cation exchange resin.

As a cation including platinum group metals having such an adsorptive property, there are complex ions of platinum group metals, e.g. platinum ammine complex cations such as [Pt(NH₃)₄]²⁺ and [Pt(NH₃)₆]⁴⁺ and ruthenium ammine complex cations such as [Ru(NH₃)₄]²⁺ and [Ru(NH₃)₆]³⁺.

In the fourth step, the catalyst-supporting powder of the present invention is obtained by chemically reducing the cation of the catalyst metal adsorbed on the cation exchange resin using a reducing agent. As the reducing agent to be used in this step, for example, hydrogen gas can be mentioned. The hydrogen gas is preferable to be used in form of a mixed gas (hydrogen-mixed gas) with an inert gas such as nitrogen, helium or argon.

Herein, owing to the special technical features that the fluorine atom-containing polymer material is added in the first step of the above-mentioned production method, it is made possible to inevitably cause conversion into the special technical features that the fluorine atom-containing polymer material is contained in the inside of the catalyst-supporting powder, which is a product. Accordingly, the production method invention and the product invention in this application mutually have common special technical features.

(4) In the catalyst-supporting powder of the present invention, it is preferable that the ratio of the fluorine atom-containing polymer material to the carbon material is not lower than 10 mass % and not higher than 120 mass %.

It is because in the case of a catalyst layer formed using the catalyst-supporting powder containing the fluorine atom-containing polymer material in an amount higher than 120 mass % to the carbon material, the internal resistance due to the electron conduction is increased since the fluorine atom-containing polymer material is insulating. Further, it is because in the case of a catalyst layer formed using the catalyst-supporting powder containing the fluorine atom-containing polymer material in an amount lower than 10 mass % to the carbon material, the effect of the water repelling property cannot be exhibited sufficiently. Accordingly, the ratio of the fluorine atom-containing polymer material to the carbon material in the present invention is preferable to be not lower than 10 mass % and not higher than 120 mass %. Further, it is also because within the above-mentioned range, it is made clear from the results of Examples or the like described later that the decay rate of cell voltage becomes so low to an extent that even a person skilled in the technical field of the Invention cannot expect.

To obtain the catalyst-supporting powder in which the mass ratio is limited in the above-mentioned manner, the ratio of the fluorine atom-containing polymer material to the carbon material may be adjusted in the first step.

Herein, practical examples of the fluorine atom-containing polymer material to be used for the catalyst-supporting powder of the present invention may include FEP (tetrafluoroethylene-hexafluoropropylene copolymer), PVdF (polyvinylidene fluoride), and PTFE (polytetrafluoroethylene). The fluorine atom-containing polymer material to be used for the catalyst-supporting powder of the present invention does not include polymers having ion exchange groups such as cation exchange resins.

(5) As the catalyst metal to be used for the catalyst-supporting powder of the present invention are preferably platinum group metals such platinum, rhodium, ruthenium, iridium, palladium, and osmium. It is because these platinum group metals have high catalytic activity on the electrochemical reduction reaction of oxygen and oxidation reaction of hydrogen. Among them are alloys containing platinum and ruthenium particularly preferable as a catalyst for an anode since high tolerance performance to CO poisoning can be expected. Further, by using an alloy containing at least one metal selected from a group consisting of magnesium, aluminum, vanadium, chromium, manganese, iron, cobalt, nickel, copper, zinc, silver, and tungsten in combination with a platinum group metal as a catalyst metal, it can be expected to save the use amount of platinum group metals, improve the tolerance performance to CO poisoning, and the high activity on the reduction reaction of oxygen.

For the carbon material to be used for the catalyst-supporting powder of the present invention, those having high electron conductivity are preferable. For example, acetylene black and furnace black may be used.

As the cation exchange resin to be used for the catalyst-supporting powder of the present invention can be mentioned preferably perfluorocarbon sulfonic acid type, styrene-divinylbenzenesulfonic acid type cation exchange resins or cation exchange resins having a carboxyl group as an ion exchange group.

Further, the amount of the cation exchange resin to be contained in the catalyst-supporting powder of the present invention is preferably not lower than 25 mass % and not higher than 150 mass % to the carbon material. The reason for that is as follows.

In a catalyst layer formed by using a catalyst-supporting powder of which the carbon material contains a cation exchange resin in an amount more than 150 mass %, the layer of the cation exchange resin formed between the carbon material and the carbon material cuts parts of the electron conductive passage, so that the utilization of the catalyst metal is lowered. On the other hand, in a catalyst layer using a catalyst-supporting powder in which the ratio of the cation exchange resin is lower than 25 mass %, since the cation exchange resin is not sufficiently continuous, the internal resistance attributed to the proton movement becomes high. Accordingly, the ratio of the cation exchange resin to the carbon material in the catalyst-supporting powder of the present invention is preferably adjusted to be in a range not lower than 25 mass % and not higher than 150 mass %. Accordingly, it is made possible to keep both of the electron conductivity and proton conductivity of the catalyst layer using the catalyst-supporting powder of the present invention at a high level.

(6) Additionally, the present application is based on the application for patent (JP-A No. 2005-030949) submitted to Japan Patent Office on Feb. 7, 2005, the disclosure of which is incorporated herein by reference in its entirety.

### BRIEF DESCRIPTION OF THE DRAWINGS

FIG. 1 shows a relationship between a cell voltage and a ratio of FEP to a carbon material of a catalyst-supporting powder, with respect to the polymer electrolyte fuel cells of Examples 1 to 6 and Comparative Example 1;

FIG. 2 shows a relationship between a decay rate of the cell voltage and a ratio of FEP to the carbon material of a catalyst-supporting powder, with respect to the polymer electrolyte fuel cells of Examples 1 to 6 and Comparative Example 1;

FIG. 3 shows TEM photographs of the catalyst-supporting powders produced in Example 1 and Comparative Example 2;

FIG. 4 shows the decay rate of the cell voltage, with respect to the polymer electrolyte fuel cells of Example 1 and Comparative Examples 1 and 2; and

FIG. 5 shows a relationship between the cell voltage and the ratio of a cation exchange resin to a carbon powder of the catalyst-supporting powder, with respect to the polymer electrolyte fuel cells of Examples 1 and 15 to 19.

### DETAILED DESCRIPTION OF THE PREFERRED EMBODIMENTS

Hereinafter, the present invention will be described with reference to comparison of preferred Examples with Comparative Examples.

### (1) Examples 1 to 6 and Comparative Examples 1 and 2

### Example 1

(a) A catalyst-supporting powder containing a fluorine atom-containing polymer material in an amount of 100 mass % and a cation exchange resin in an amount of 67 mass % to a carbon material was prepared in the following process.

In the first step, a mixture containing 15 g of a carbon powder (Vulcan XC-72, manufactured by Cabot), 200 g of a cation exchange resin solution (Nation, 5 mass % solution, manufactured by Aldrich), 28 g of a FEP dispersion (54 mass %, FEP 120-J, manufactured by Du Pont-Mitsui Fluorochemicals Co., Ltd.), 150 g of water, and 300 g of 2-propanol was prepared.

In the second step, the mixture was dried by spray drying and granulated to produce a mixed powder containing the cation exchange resin, the carbon powder, and FEP. In this mixed powder, it was supposed that the carbon powder was coated with the cation exchange resin and FEP.

In the third step, the mixed powder was immersed in an aqueous solution of [Pt(NH₃)₄]Cl₂ (50 mmol/L solution) to adsorb [Pt(NH₃)₄]²⁺ in the cluster portions of the cation exchange resin.

In the fourth step, the mixed powder was washed and reduced at 180° C. in a hydrogen atmosphere to prepare a catalyst-supporting powder A of Example 1.

The amount of platinum contained in the catalyst-supporting powder was 2.03 mass % to the catalyst-supporting powder. Herein, the amount of platinum contained in the catalyst-supporting powder can be quantitatively determined by extracting platinum of the catalyst-supporting powder with aqua regia and successively carrying out ICP atomic emission spectrometry of the amount of platinum contained in the aqua regia. The amount of the FEP contained in the catalyst-supporting powder A was 100 mass % to the carbon material.

(b) Next, a catalyst layer containing this catalyst-supporting powder A was produced by the following method.

A mixture containing 6.0 g of the catalyst-supporting powder A, 9.0 g of CaCO₃ as a pore forming agent, and 45 g of N-methyl-2-pyrrolidone (manufactured by Mitsubishi Chemical Corporation) was produced. The mixture was applied to a titanium sheet and dried to form a catalyst layer on the titanium sheet. Successively, the catalyst layer was cut in a square of 5 cm on a side to give a catalyst layer. At the time of applying the mixture, the thickness of the application was adjusted to control the amount of the platinum contained in the catalyst layer to be 0.060 mg/cm².

(c) Further, a membrane electrode assembly for a polymer electrolyte fuel cell, and a polymer electrolyte fuel cell were produced by the following method.

The obtained catalyst layers and a cation exchange resin membrane (Nafion 112, manufactured by Du Pont, film thickness about 50 μm) were pressed at 17.1 MPa and 160° C. to transfer the catalyst layers to both faces of the cation exchange resin membrane and the titanium sheets were peeled off to produce a membrane electrode assembly.

Next, this membrane electrode assembly was immersed in an aqueous nitric acid solution (0.5 mol/L) to elute the pore forming agent to carry out pore forming treatment for the catalyst layers and thereafter, the membrane electrode assembly was washed with an aqueous sulfuric acid solution (0.5 mol/L) and water. Further, conductive and porous carbon papers (TGP-H-060, manufactured by Toray Industries, Inc.) provided with a water repelling property were attached on both faces of the assembly and then the resulting assembly was sandwiched between a pair of gas flow plates and finally between a pair of current collector plates to produce a polymer electrolyte fuel cell of Example 1.

### Example 2

A catalyst-supporting powder B was produced in the same manner as Example 1, except that amount of FEP contained in the catalyst-supporting powder was changed to 10 mass % to the carbon powder. Successively, a polymer electrolyte fuel cell of Example 2 was produced in the same manner as Example 1 using the catalyst-supporting powder B.

### Example 3

A catalyst-supporting powder C was produced in the same manner as Example 1, except that amount of FEP contained in the catalyst-supporting powder was changed to 40 mass % to the carbon powder. Successively, a polymer electrolyte fuel cell of Example 3 was produced in the same manner as Example 1 using the catalyst-supporting powder C.

### Example 4

A catalyst-supporting powder D was produced in the same manner as Example 1, except that amount of FEP contained in the catalyst-supporting powder was changed to 72 mass % to the carbon powder. Successively, a polymer electrolyte fuel cell of Example 4 was produced in the same manner as Example 1 using the catalyst-supporting powder D.

### Example 5

A catalyst-supporting powder E was produced in the same manner as Example 1, except that amount of FEP contained in the catalyst-supporting powder was changed to 120 mass % to the carbon powder. Successively, a polymer electrolyte fuel cell of Example 5 was produced in the same manner as Example 1 using the catalyst-supporting powder E.

### Example 6

A catalyst-supporting powder F was produced in the same manner as Example 1, except that amount of FEP contained in the catalyst-supporting powder was changed to 151 mass % to the carbon powder. Successively, a polymer electrolyte fuel cell of Example 6 was produced in the same manner as Example 1 using the catalyst-supporting powder F.

### Comparative Example 1

A catalyst-supporting powder G was produced in the same manner as Example 1, except no FEP was contained in the catalyst-supporting powder. Successively, a polymer electrolyte fuel cell of Comparative Example 1 was produced in the same manner as Example 1 using the catalyst-supporting powder G.

### Comparative Example 2

The present inventors produced a polymer electrolyte fuel cell of Comparative Example 2 as follows.

After the catalyst-supporting powder G (that is, a catalyst-supporting powder containing no FEP) was produced, the catalyst-supporting powder G and an FEP dispersion were mixed. Thereafter, the mixture was filtered by suction filtration to obtain a powder. The powder was dried at 80° C. to produce a catalyst-supporting powder H containing 100 mass % of FEP to the carbon powder.

A polymer electrolyte fuel cell of Comparative Example 2 was produced in the same manner as Example 1 using the catalyst-supporting powder H.

The reason for the execution of such Comparative Example 2 was to investigate whether the water repelling effect, which is an effect of the present invention, would be exhibited or not and to carry out comparison in the case FEP was added after the catalyst-supporting powder was produced but not added during the production steps as the case of Examples 1 to 6.

### Experiment 1

The voltage-current characteristics of each of the polymer electrolyte fuel cells of Examples 1 to 6 and Comparative Example 1 were measured under conditions of a cell temperature of 70° C., pure hydrogen as an anode gas, an anode gas utilization of 80%, an anode gas humidifying temperature of 70° C., air as a cathode gas, a cathode gas utilization of 40%, and a cathode gas humidifying temperature of 70° C. A relationship between the cell voltage and the ratio of FEP to the carbon material of the catalyst-supporting powder at a current density of 300 mA/cm² for the polymer electrolyte fuel cells of Examples 1 to 6 and Comparative Example 1 is shown in FIG. 1.

It can be understood from FIG. 1 that the cell voltage in the case that the ratio of FEP to the carbon material of the catalyst-supporting powder is in a range not higher than 120 mass % (Examples 1 to 5 and Comparative Example 1) is higher than that in the case the ratio is 150 mass % (Example 6). It is supposedly attributed to that since the catalyst layer containing the catalyst-supporting powder of Example 6 contains a large quantity of insulating FEP, the electron conductivity of the catalyst layer is decreased and the internal resistance is increased. Accordingly, it is preferable to adjust the ratio of FEP to the carbon material in the catalyst-supporting powder in a range not higher than 120 mass % in order to keep the electron conductivity of the catalyst at a high level.

### Experiment 2

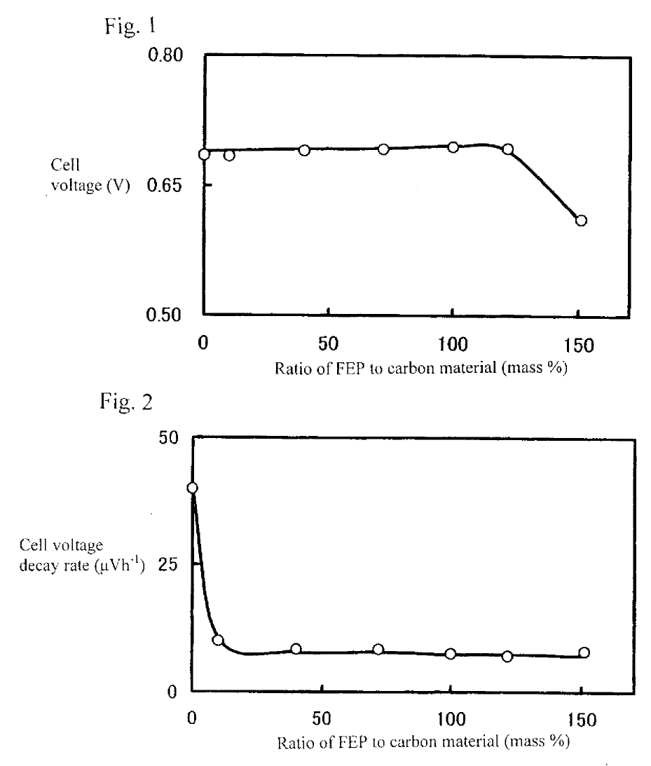

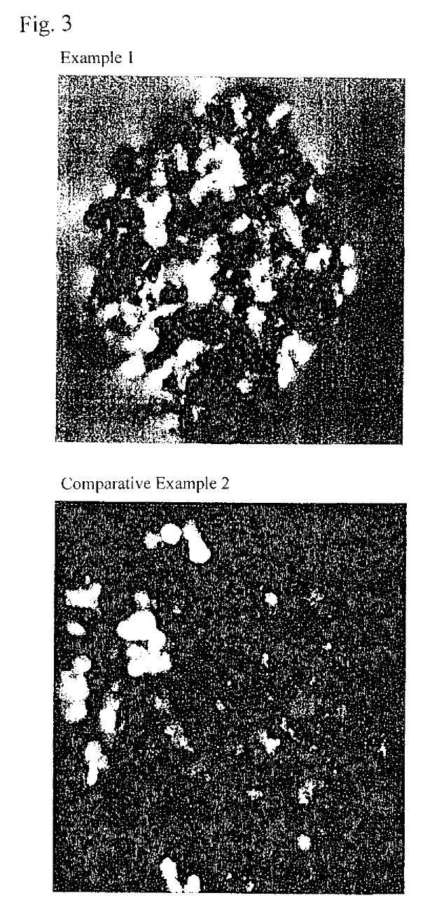

The change in of cell voltage with the operation of time was measured (durability test) by operating each of the polymer electrolyte fuel cells of Examples 1 to 6 and Comparative Example 1 at a current density of 300 mA/cm² under conditions of a cell temperature of 70° C., pure hydrogen as an anode gas, an anode gas utilization of 80%, an anode gas humidifying temperature of 70° C., air as a cathode gas, a cathode gas utilization of 40%, and a cathode gas humidifying temperature of 70° C. A relationship between decay rate of the cell voltage and the ratio of FEP to the carbon material of the catalyst-supporting powder for the polymer electrolyte fuel cells of Examples 1 to 6 and Comparative Example 1 is shown in FIG. 2.

It can be understood from FIG. 2 that the decay rate of the cell voltage is superior in the case the ratio of FEP to the carbon material of the catalyst-supporting powder is in a range not lower than 10 mass % (Examples 1 to 6) as compared with Comparative Example 1 where no FEP is contained. It is supposedly attributed to that since the addition of PEP is insufficient for the catalyst layer containing the catalyst-supporting powder in the case the ratio of FEP is lower than 10 mass %, the water repelling property is not supplied sufficiently. That is, in the case the ratio of FEP to the carbon material is in a range not lower than 10 mass %, the catalyst-supporting powder is provided with a sufficient water repelling property and accordingly the decay of the cell voltage can be suppressed.

From the above, the ratio of FEP contained in the catalyst-supporting powder of the present invention to the carbon material is preferably not lower than 10 mass % and not higher than 120 mass %, and in the case within the range, the electron conductivity and the water repelling property of the catalyst layer become optimum, it is supposedly made possible that the decay of the cell voltage of a fuel cell provided with the catalyst layer can be suppressed.

### Observation 1

The results of TEM observation of cross sections of the catalyst-supporting powder A and the catalyst-supporting powder H are shown in FIG. 3. The white particles in the figure are of PEP. The gray particles in the figure are of carbon particles.

From FIG. 3, it can be understood that in the case of the catalyst-supporting powder A, FEP is homogeneously dispersed in the inside of the catalyst-supporting powder being in form of an agglomerate, meanwhile in the case of the catalyst-supporting powder H, PEP does not exist in the inside of the catalyst-supporting powder and is agglomerated outside.

As described above, it was made clear that in the case the fluorine atom-containing polymer material is added in the first step of the production method of the present invention, the polymer material can be contained in the inside of the catalyst-supporting powder; however in the case of production by the method of Comparative Example 2, the polymer material cannot be contained in the inside of the catalyst-supporting powder.

### Experiment 3

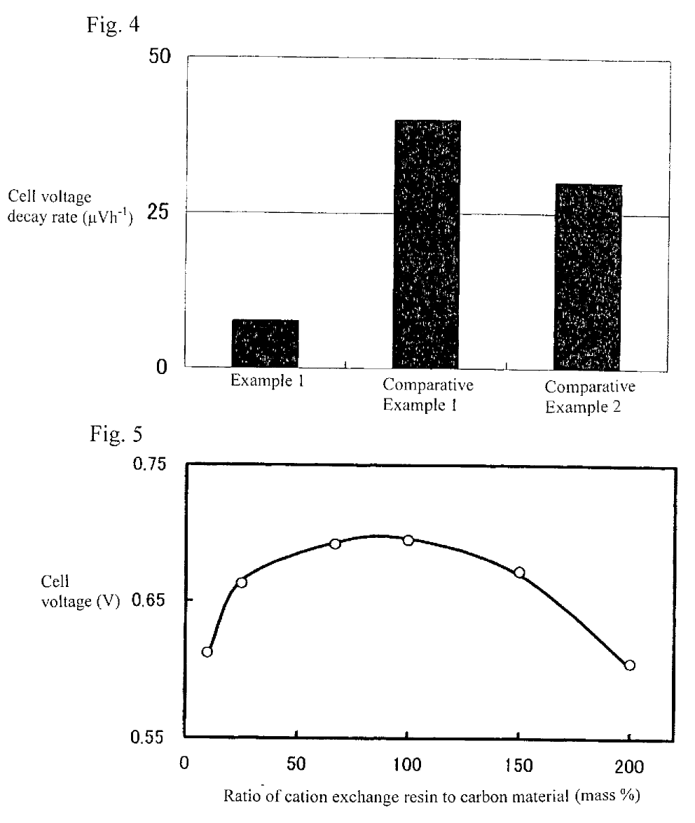

The change in cell voltage with the operation time was measured (durability test) by operating each of the polymer electrolyte fuel cells of Example 1 and Comparative Examples 1 to 2 at a current density of 300 mA/cm² under conditions of a cell temperature of 70° C., pure hydrogen as an anode gas, an anode gas utilization of 80%, an anode gas humidifying temperature of 70° C., air as a cathode gas, a cathode gas utilization of 40%, and a cathode gas humidifying temperature of 70° C. The decay rate of the cell voltage of each of the polymer electrolyte fuel cells of Example 1 and Comparative Examples 1 and 2 are shown in FIG. 4.

It can be understood from FIG. 4 that the cell voltage decay rate of Example 1 is superior to not only that of Comparative Example 1 in which no FEP was added but also that of Comparative Example 2 in which FEP was added in the same amount. As described above, it is supposedly attributed to that in the case of the catalyst-supporting powder G used in Comparative Example 2, FEP does not exist in the inside of the catalyst-supporting powder and accordingly the effect of water repelling property is low. That is, existence of FEP in the inside of the catalyst-supporting powder more efficiently suppresses the flooding phenomenon and accordingly, the cell voltage decay of the fuel cell comprising this catalyst-supporting powder can be considerably suppressed.

### (2) Examples 7 to 10 and Comparative Example 3

### Example 7

A catalyst-supporting powder I which contained PTFE in an amount of 10 mass % to a carbon powder was produced in the same manner as Example 2, except that PTFE was used in place of FEP as a fluorine atom-containing polymer material. Successively, a polymer electrolyte fuel cell of Example 7 was produced in the same manner as Example 2 using the catalyst-supporting powder I.

### Example 8

A catalyst-supporting powder J was produced in the same manner as Example 7, except that the amount of PTFE contained in the catalyst-supporting powder was changed to 40 mass % to the carbon powder. Successively, a polymer electrolyte fuel cell of Example 8 was produced in the same manner as Example 7 using the catalyst-supporting powder J.

### Example 9

A catalyst-supporting powder K was produced in the same manner as Example 7, except that the amount of PTFE contained in the catalyst-supporting powder was changed to 120 mass % to the carbon powder. Successively, a polymer electrolyte fuel cell of Example 9 was produced in the same manner as Example 7 using the catalyst-supporting powder K.

### Example 10

A catalyst-supporting powder L was produced in the same manner as Example 7, except that the amount of PTFE contained in the catalyst-supporting powder was changed to 151 mass % to the carbon powder. Successively, a polymer electrolyte fuel cell of Example 10 was produced in the same manner as Example 7 using the catalyst-supporting powder L.

### Comparative Example 3

A catalyst-supporting powder M was produced in the same manner as Example 7, except that no PTFE was contained in the catalyst-supporting powder. Successively, a polymer electrolyte fuel cell of Comparative Example 3 was produced in the same manner as Example 7 using the catalyst-supporting powder M.

### Experiment 4

With respect the polymer electrolyte fuel cells of Examples 7 to 10 and Comparative Example 3, the voltage-current characteristics and the change in cell voltage with the lapse of time were measured under the same conditions as those of Example 1 and a relationship of the cell voltage and the ratio of PTFE to the carbon material in the catalyst-supporting powder at a current density of 300 mA/cm² and a relationship of the decay rate of the cell voltage and the ratio of PTFE to the carbon material in the catalyst-supporting powder were measured.

The results were similar to those of the case of using FEP as the fluorine atom-containing polymer material and it was also found that the electron conductivity and the water repelling property of the catalyst layer became optimum in the case the ratio of PTFE contained in the catalyst-supporting powder of the present invention to the carbon material was not lower than 10 mass % and not higher than 120 mass %.

### (3) Examples 11 to 14 and Comparative Example 4

### Example 11

A catalyst-supporting powder N which contained PVdF in an amount of 10 mass % to a carbon powder was produced in the same manner as Example 7, except that PVdF was used in place of PTFE as a fluorine atom-containing polymer material. Successively, a polymer electrolyte fuel cell of Example 11 was produced in the same manner as Example 7 using the catalyst-supporting powder N.

### Example 12

A catalyst-supporting powder O was produced in the same manner as Example 11, except that the amount of PVdF contained in the catalyst-supporting powder was changed to 40 mass % to the carbon powder. Successively, a polymer electrolyte fuel cell of Example 12 was produced in the same manner as Example 11 using the catalyst-supporting powder O.

### Example 13

A catalyst-supporting powder P was produced in the same manner as Example 11, except that the amount of PVdF contained in the catalyst-supporting powder was changed to 120 mass % to the carbon powder. Successively, a polymer electrolyte fuel cell of Example 13 was produced in the same manner as Example 11 using the catalyst-supporting powder P.

### Example 14

A catalyst-supporting powder Q was produced in the same manner as Example 11, except that the amount of PVdF contained in the catalyst-supporting powder was changed to 151 mass % to the carbon powder. Successively, a polymer electrolyte fuel cell of Example 14 was produced in the same manner as Example 11 using the catalyst-supporting powder Q.

### Comparative Example 4

A catalyst-supporting powder R was produced in the same manner as Example 11, except that no PVdF was contained in the catalyst-supporting powder. Successively, a polymer electrolyte fuel cell of Comparative Example 4 was produced in the same manner as Example 11 using the catalyst-supporting powder R.

### Experiment 5

With respect the polymer electrolyte fuel cells of Examples 11 to 14 and Comparative Example 4, the voltage-current characteristics and the change in cell voltage with the operation time were measured under the same conditions as those of Example 1 and a relationship between the cell voltage and the ratio of PVdF to the carbon material in the catalyst-supporting powder at a current density of 300 mA/cm² and a relationship of the decay rate of the cell voltage and the ratio of PVdF to the carbon material in the catalyst-supporting powder were measured.

The results were similar to those of the case of using FEP or PTFE as the fluorine atom-containing polymer material and it was also found that the electron conductivity and the water repelling property of the catalyst layer became optimum in the case the ratio of PVdF contained in the catalyst-supporting powder of the present invention to the carbon material was not lower than 10 mass % and not higher than 120 mass %.

As described above, even in the case the types of fluorine atom-containing polymer materials differ, it was found that the ratio of the fluorine atom-containing polymer material contained in the catalyst-supporting powder of the present invention to the carbon material was optimum to be not lower than 10 mass % and not higher than 120 mass %.

### (4) Examples 15 to 19

### Example 15

A catalyst-supporting powder S was produced in the same manner as Example 1, except that amount of the cation exchange resin contained in the catalyst-supporting powder was changed to 10 mass % to the carbon powder. Successively, a polymer electrolyte fuel cell of Example 15 was produced in the same manner as Example 1 using the catalyst-supporting powder S.

### Example 16

A catalyst-supporting powder T was produced in the same manner as Example 15, except that amount of the cation exchange resin contained in the catalyst-supporting powder was changed to 25 mass % to the carbon powder. Successively, a polymer electrolyte fuel cell of Example 16 was produced in the same manner as Example 15 using the catalyst-supporting powder T.

### Example 17

A catalyst-supporting powder U was produced in the same manner as Example 15, except that amount of the cation exchange resin contained in the catalyst-supporting powder was changed to 100 mass % to the carbon powder. Successively, a polymer electrolyte fuel cell of Example 17 was produced in the same manner as Example 15 using the catalyst-supporting powder U.

### Example 18

A catalyst-supporting powder V was produced in the same manner as Example 15, except that amount of the cation exchange resin contained in the catalyst-supporting powder was changed to 150 mass % to the carbon powder. Successively, a polymer electrolyte fuel cell of Example 18 was produced in the same manner as Example 15 using the catalyst-supporting powder V.

### Example 19

A catalyst-supporting powder W was produced in the same manner as Example 15, except that amount of the cation exchange resin contained in the catalyst-supporting powder was changed to 200 mass % to the carbon powder. Successively a polymer electrolyte fuel cell of Example 19 was produced in the same manner as Example 15 using the catalyst-supporting powder W.

### Experiment 6

The voltage-current characteristics of each of the fuel cells of Example 1 and Examples 15 to 19 were measured under conditions of a cell temperature of 70° C., pure hydrogen as an anode gas, an anode gas utilization of 80%, an anode gas humidifying temperature of 70° C., air as a cathode gas, a cathode gas utilization of 40%, and a cathode gas humidifying temperature of 70° C. A relationship between the cell voltage and the ratio of the cation exchange resin to the carbon material of the catalyst-supporting powder for the fuel cells of Example 1 and Examples 15 to 19 at 300 mA/cm² is shown in FIG. 5.

It can be understood from FIG. 5 that the cell voltages of Examples (practically, corresponding to Examples 1, 16, 17, and 18) in which the ratio of the cation exchange resin to the carbon material of the catalyst-supporting powder is in a range not lower than 25 mass % and not higher than 150 mass % are higher than the cell voltages of Example 15 and Example 19.

It is probably attributed to that with respect to the catalyst layer using the catalyst-supporting powder in the amount of 200 mass % (Example 19), the layer of the cation exchange resin formed between the carbon material and the carbon material cuts parts of electron conductive passage and accordingly, the utilization of the catalyst metal is lowered. On the other hand, it is supposed that with respect to the catalyst layer using the catalyst-supporting powder in which the cation exchange resin is in the amount of 10 mass % (Example 15), the cation exchange resin is not sufficiently continued and accordingly, the internal resistance is increased due to the proton movement.

Consequently, to keep both of the electron conductivity and the proton conductivity at a high level, it is preferable to adjust the ratio of the cation exchange resin to the carbon material in the catalyst-supporting powder in a range not lower than 25 mass % and not higher than 150 mass %. In this range, unexpectedly good consequences which cannot be easily expected by a person skilled in the art can be accomplished.

A polymer electrolyte fuel cell has been used widely in an industrial field. Accordingly, the present invention relating to the catalyst-supporting powder and the production method of the catalyst-supporting powder is also industrially applicable.

What is claimed is:

1. A catalyst-supporting powder being an agglomerate formed by agglomeration of a fluorine atom-containing polymer material, a catalyst metal, a cation exchange resin, and a carbon material, wherein said polymer material is contained in the inside of said agglomerate.

2. The catalyst-supporting powder according to claim 1, wherein said catalyst metal is located mainly on a site where a proton conductive passage of said cation exchange resin contacts said carbon material.

3. The catalyst-supporting powder according to claim 1, wherein the ratio of said polymer material to said carbon material is not lower than 10 mass % and not higher than 120 mass %.

4. A production method of a catalyst-supporting powder, comprising;
a first step of producing a mixture of a fluorine atom-containing polymer material, a cation exchange resin, a carbon material, and a solvent;
a second step of obtaining a mixed powder of said polymer material, said cation exchange resin, and said carbon material by drying said mixture;
a third step of adsorbing a cation of a catalyst metal on a fixed ion of said cation exchange resin in said mixed powder; and
a fourth step of reducing said cation.

5. A membrane electrode assembly for a polymer electrolyte fuel cell comprising the catalyst-supporting powder according to claim 1.

6. A membrane electrode assembly for a polymer electrolyte fuel cell comprising the catalyst-supporting powder according to claim 2.

7. A membrane electrode assembly for a polymer electrolyte fuel cell comprising the catalyst-supporting powder according to claim 3.

8. A membrane electrode assembly for a polymer electrolyte fuel cell comprising the catalyst-supporting powder obtained by the production method according to claim 4.

9. A polymer electrolyte fuel cell comprising the membrane electrode assembly for a polymer electrolyte fuel cell according to claim 5.

10. A polymer electrolyte fuel cell comprising the membrane electrode assembly for a polymer electrolyte fuel cell according to claim 6.

11. A polymer electrolyte fuel cell comprising the membrane electrode assembly for a polymer electrolyte fuel cell according to claim 7.

12. A polymer electrolyte fuel cell comprising the membrane electrode assembly for a polymer electrolyte fuel cell according to claim 8.
